(19) United States
(12) Patent Application Publication
(10) Pub. No.: US 2008/0210136 A1
(43) Pub. Date: Sep. 4, 2008

(54) Jointing and Surface Compound for Construction Elements, Its Preparation Process and Building Process of a Structure

(75) Inventors: Alain Petit, Isle Sur Sorgue (FR); Marc Domenech, La Roque Sur Pernes (FR)

Correspondence Address: BUCHANAN, INGERSOLL & ROONEY PC, POST OFFICE BOX 1404, ALEXANDRIA, VA, 22313-1404, US

(73) Assignee: LAFARGE PLATRES, Avignon Cedex 9 (FR)

(21) Appl. No.: 12/065,676

(22) PCT Filed: Sep. 12, 2006
(86) PCT No.: PCT/FR2006/002084

§ 371 Date: Mar. 4, 2008

(30) Foreign Application Priority Data
Sep. 12, 2005 (FR) 0509259

(51) Int. Cl. C04B 11/00; C04B 26/04; E04G 23/02; E04G 21/14; E04F 21/165

(52) U.S. Cl. 106/780; 106/772; 524/5; 524/4; 524/8; 52/747.1; 52/742.14

(57) ABSTRACT

The object of the invention is a drying compound comprising from 50 to 85% of FGD gypsum and/or natural or processed gypsum, in mass percentages based on the total mass of the compound, presenting the following particle size characteristics: (i) a d₅₀ from 35 to 70 μm and (ii) a span (d₉₀−d₁₀/d₅₀) lower than 2.

The object of the invention is also a preparation process of the compound according to the invention.

Finally, the object of the invention is a building process of a structure using this compound.

### DOMAIN OF THE INVENTION

The present invention provides a jointing compound for construction elements, particularly gypsum boards with paper facings, as well as a building process of a structure such as a partition wall, a wall lining or a ceiling. The invention relates to a drying compound called “ready-mix”. The compound according to the invention is preferably a “2-in-1” compound, that is a compound that fulfills both the filling and the finishing functions.

### TECHNOLOGICAL BACKGROUND

The use of gypsum boards is well known to make partition walls, to line vertical or inclined elements or to put up ceilings, suspended or not.

These boards generally comprise a core mostly made of gypsum, covered on each of its sides by a sheet serving both as reinforcement and as facing and that can comprise cardboard or mineral fibers.

Generally, the gypsum boards are assembled with a first compound and the joints are finished between the boards with a complementary compound. A filling compound (or also called a patching compound) is used as a complement to the tape, and generally presents a relatively low shrinkage, good embedding and good adherence to the joint tape. A finishing compound is used for the last pass to finish the structure so that it presents a monolithic surface.

More and more often drying compounds are used that fulfill the various functions at the same time. These compounds are called “2-in-1”, that is a compound that fulfils both the filling and the finishing functions. Moreover, drying compounds supplied in cans with water that is later eliminated are also used; such compounds are qualified as “ready-mix”.

There always exists a need for a compound presenting good application qualities on the support and workability.

### RESUME OF THE INVENTION

The invention therefore provides a drying compound comprising from 50 to 85% of FGD gypsum.

The invention therefore also provides a drying compound comprising from 50 to 85% of natural gypsum or processed gypsum, in mass percentages relative to the total mass of the compound, presenting the following particle size characteristics: (i) a d₅₀ from 35 to 70 μm (preferably from 36 to 70 μm, more preferably from 37 to 70 μm) and (ii) a span (d₉₀−d₁₀/d₅₀) lower than 2.

The invention also provides a preparation process for the compound according to the invention wherein the components of the compound are mixed in any order.

Finally, the invention provides a building process of a structure, including the juxtaposition of gypsum boards presenting a facer, preferably paper, possibly applying tape, and covering the joint between the boards using a compound according to the invention.

The invention provides a compound that presents good workability. The workability can be divided in two parts, the first part being related to the flowing threshold of the compound, that is, the energy necessary to apply the compound, and the second being the spread after the flowing threshold. Good spreads are particularly sought after.

### DETAILED DESCRIPTION OF THE INVENTION

### Compound According to the Invention

The compound according to the invention comprises, as previously mentioned, a mineral filler that is the main characteristic of this compound. This mineral filler is an FGD gypsum, (Flue Gas Desulfuration) and/or a natural or processed gypsum having the following characteristics: (i) a d₅₀ of from 35 to 70 μm and (ii) a span (d₉₀−d₁₀/d₅₀) lower than 2. The value of the span characterizes a very narrow particle size distribution. As a reminder, a typically-used limestone as a filler in compounds presents (i) a d₅₀ of from 15 to 30 μm and (ii) a span (d₉₀−d₁₀/d₅₀) of from 2 to 4. The particle size distribution can be obtained by an appropriate treatment of a natural or processed gypsum by grinding and sieving. Such techniques are known. Alternately, an FGD gypsum can be used such as directly obtained at the outlet of a desulfuration unit, these gypsums generally present the required particle size distributions.

The definition of d₅₀ is recalled, abbreviated to d(v,50), that is the size of the particle for which 50% of the sample has a smaller size and 50% of the sample has a larger size. This value is also known by the name of MMD (Mass Median Diameter), the values of mass and volume being the same, simply derived one from the other by the density. The value of d₁₀ is the size of the particle for which 10% of the sample is below this size. The value of d₉₀ is the size of the particle for which 90% of the sample is below this size.

The amount of gypsum filler according to the invention is typically of from 50 to 85% of the total weight of the compound, preferably from 55 to 75%.

The mineral filler is the main characteristic of the compound according to the invention. The other components are typical in the domain of drying compounds; the remainder includes water and possibly other components.

A complementary mineral filler can also be used, that can be any mineral filler usually-used to manufacture a jointing compound. Complementary mineral fillers include calcium carbonate, calcium sulfate, anhydrous or dehydrate, magnesium carbonate, dolomite, silicas, silicates, aluminates or others. Preferably the FGD gypsum and/or with a specific particle size distribution is the only one used.

A light filler (called “light weight aggregate”) can also be used if desired. An example is perlite, notably expanded and in particular hydrophobe (notably with a d50 of from 20 to 100 microns).

The binder used is a typical binder used in the art of compounds, dispersible in the aqueous phase. It can come in the form of a dry extract or in the form, for example of latex, at 50% in water. Examples of such binders, include polyvinyl alcohol homopolymers, polyvinyl acetate homopolymers (plasticized or non plasticized), the copolymers: ethylene/vinyl acetate (EVA) plasticized or non plasticized, ethylene/vinyl versatate, vinyl acetate/vinyl versatate, polyacrylics, the copolymers: vinyl acetate/acrylic, the copolymers: styrenic/acrylic, styrene/butadiene, terpolymers: vinyl acetate/vinyl versatate/vinyl maleate, vinyl acetate/vinyl versatate/acrylics, the terpolymer vinyl acetate/ester vinyl of an acid (long chain)/ester of acrylic acid, the acrylic terpolymers and mixtures thereof. Combinations of binders could be used in this way: co- or terpolymer vinyl acetate/vinylic copolymer and vinylic copolymer/styrenic/acrylic copolymer. When these polymers are provided, they are either in the form of powder, or in the form of dispersion in water (generally at an approximate level of 50%).

The proportion of organic binder is generally of from 0.5 to 20% in weight, preferably from 1 to 8% of the total weight of the compound.

Other than the elements mentioned above, the compound generally comprises one or several of the following other elements:
a spreading agent in amounts for example of from 0.5 to 10%, preferably from 1 to 5%; this spreading agent can be a silcated agent (different from the mineral filler) notably a clay (the attapulgite type) or it can be any known spreading agent; this agent is notably a clay and/or talc and/or mica;
a workability agent that is a water-retaining and thickening agent, in amounts for example from 1 to 15%; this water-retaining agent can be a cellulose derivative (cellulose ether) such as methylhydroxyethylcellulose;
an anti-foaming agent, in amounts for example of from 1 to 15%; this anti-foaming agent is for example a non-ionic surfactant;
a hydrophobe agent in amounts for example of from 1 to 15%; this agent can notably be a fatty acid, a fatty acid salt, wax or a silicone derivative; the fatty acid, oleic acid or stearic acid are preferably used, the alkaline or alkaline-earth salts are preferred for the fatty acid salt, particularly sodium, potassium, magnesium or calcium salts; the siliconates, silanes, hydrogenated silicone oils, silicone emulsions, amine-silicone emulsions, alkyl-siloxane resins such as hydrogenomethylpolysiloxane and amine polydimethylsiloxane as well as their mixes can be noted for the silicone derivatives.
starch and/or a starch derivative, in amounts generally of from 0.05 to 5%, preferably from 0.1 to 1% of the total weight of the compound;
biocides;
pigments and brighteners;
dispersing agents;
anti-freeze agents;
etc.

The compound according to the invention presents a density generally of from 1 to 1.8, preferably from 1.1 to 1.5.

The compound generally presents a Brookfield viscosity of the compound of from 200 000 to 800 000 cps, advantageously from 300 000 to 600 000 cps. Generally the variation between measurements after 1 day and after 7 days is relatively low (7 day/1 day ratio lower than 1.3).

The compound according to the invention presents a pH, for example of from 8 to 9.5.

The compound according to the invention presents a dry extract that can vary, for example from 60 to 85%, preferably from 70 to 80%.

The compound according to the invention is a compound called drying (“ready-mix”). The compound according to the invention is preferably a “2-in-1”, compound, that is a compound that fulfills the filling and the finishing functions at the same time.

The compound according to the invention presents, besides its very good easiness-to-handle (workability), one or several of the following properties:
good adherence on the paper that is the facer of the gypsum boards (there is in fact cohesion failure in the gypsum board; there is delamination of the facing paper);
good embedding and good adherence of the joint tape (there is delamination of the latter);
low shrinkage after drying (for example less than 20% as determined by the ring test);
easy sanding.

The compound according to the invention can be prepared by mixing its components in any order or in a given order.

### Building Process According to the Invention

The compound according to the invention can be used to make, using gypsum boards, many structures such as partition walls, wall linings and ceilings, suspended or not.

The compound according to the invention is particularly suitable to build structures using gypsum boards with paper facers.

The construction of a structure using gypsum boards generally includes the juxtaposition of gypsum boards, filling the space between the boards with a filling compound, applying tape (usually paper), covering the tape with the filling compound, then applying over the filling compound a finishing compound. Alternatively, the filling of the space between the boards using a filling compound and tape application steps can be replaced by applying self-adhesive glass mesh tape (without the prior application of the filling compound).

The compound according to the invention can be the filling compound and/or the finishing compound. Preferably the compound according to the invention is both the filling compound and the finishing compound (it works then as a 2-in-1 compound).

For the joints of the recessed edges, paper tape or another usually-used means can generally be used, with a prior layer of the filling compound. For the joints on rounded edges, hence without tape, the compound is used in the same way.

### EXAMPLES

The following examples are only given as an illustration and are not at all restrictive.

The particle size data are given in volume (this is equivalent to data in mass), and were measured with a Malvern® mastersizer S apparatus, optic 300RF and device MS17, length of ray 2.4 mm. The particle size measurement was carried out by the humid method and ultrasounds. This method consisted of diluting the filler in a solvent (95% ethanol) and applying ultrasounds (a few minutes until the sample was acceptable, value “/div” lower than 20, preferably lower than 10). The sample was introduced up to an “obscuration” value of approximately 15%.

The viscosity was measured by a Brookfield viscometer (RVDVII+Pro) with a Helipath device (conditioned laboratory: speed conditions No. 2, T pin No. D, measurements after 30 sec).

### Example 1

In this example the characteristics of several gypsums with FGD origins were determined. The values were the following:

| Gypsum (origin) | d₅₀ | Span |
|---|---|---|
| US | 45.6 | 1.19 |
| Germany | 65.9 | 1.48 |
| China (1) | 39.9 | 1.87 |
| China (2) | 44.8 | 1.75 |

### Example 2

In this example the composition was determined for the characteristics given in the chart below (the FGD gypsum was the gypsum from Germany):

| Components | Quantity |
|---|---|
| Gypsum FGD | 505 |
| Water | 200 |
| Microbiocide | 0.48 |
| Nonionic surfactant | 0.85 |
| Mica | 8 |
| Clay | 10 |
| Cellulose Ether | 3.2 |
| Starch | 3 |
| Talc | 16.76 |
| EVA | 20 |

The compound was made by mixing its components. The viscosity after one day was 410 000-430 000 cps, while the viscosity after 7 days was 470 000-480 000 cps. Density was from 1.23 to 1.25, and the pH was from 8.8 to 8.73.

### Example 3

In this example, the behavior of two compounds made using FGDs with Chinese origins 1 and 2 was studied, the composition being the same as in example 2.

| | FGD China 2 | FGD China 1* |
|---|---|---|
| Aspect | Pleasant shiny paste | Pleasant shiny paste, |
| | | slight foam |
| Odor | None | None |
| Color | Light brown | Brown |
| Consistency | Very good, relatively | Slightly thicker than |
| | fluid | the other compound |
| Application | Excellent | Excellent |
| Water retention | Excellent | Excellent |
| Paper tape | Very easy | Very easy |
| (Fiber) glass | Excellent | Excellent |
| mesh tape | | |
| Filling | Excellent | Excellent |
| Shrinkage | Low | Low |
| Finish | Perfect | Perfect |
| Dried aspect | The compound behaves | The compound behaves |
| | like a self-leveling | like a self-leveling |
| | one and its aspect is | one and its aspect is |
| | excellent | excellent |
| Sanding | Easy, rapid and good | Easy, rapid and good |
| P 80 + P 150 | result | result |
| Adhesion to the | Delamination | Delamination |
| paper tape | | |

*The compound contained 10 g of additional water.

### Example 4

In this example the behavior of the compounds made using FGD from the same German origin was studied, with different sampling dates. The compositions were identical to the one in example 2, only the date of the sample of FGD gypsum changed.

| | Composition A | Composition B |
|---|---|---|
| Aspect | Pleasant shiny paste | Pleasant shiny paste, |
| | | slight foam |
| Odor | None | None |
| Color | Light brown | Light brown |
| Consistency | Very good | Slightly thicker than |
| | | the other compound |
| Application | Excellent | Excellent, with |
| | | slightly more energy |
| | | for the application |
| Water retention | Excellent | Excellent |
| Paper tape | Very easy | Very easy |
| (Fiber) glass | Excellent | Excellent |
| mesh tape | | |
| Filling | Excellent | Excellent |
| Shrinkage | Low | Low |
| Finish | Perfect | Perfect |
| Dried aspect | The compound behaves | The compound behaves |
| | like a self-leveling | like a self-leveling |
| | one and its aspect is | one and its aspect is |
| | excellent | excellent |
| Sanding | Easy, rapid and good | Easy, rapid and good |
| P 80 + P 150 | result | result |
| Adhesion to the | Delamination | Delamination |
| paper tape | | |

1. A drying compound comprising from 50 to 85% of FGD gypsum, in mass percentages based on the total mass of the compound.

2. A drying compound comprising from 50 to 85% of natural gypsum or processed gypsum, in mass percentages based on the total mass of the compound, having the following particle size characteristics: (i) a d₅₀ from 35 to 70 μm and (ii) a span (d₉₀−d₁₀/d₅₀) lower than 2.

3. A compound according to claim 2, wherein the gypsum is an FGD gypsum.

4. A compound according to claim 1, comprising from 50 to 75% of gypsum, in mass percentages based on the total mass of the compound.

5. A compound according to claim 1, comprising a binder in amounts from 0.5 to 20 weight %.

6. A compound according to claim 1, comprising a binder selected from among polyvinylic alcohol homopolymers, polyvinyl acetate homopolymers (plasticized or non plasticized), the copolymers: ethylene/vinyl acetate (EVA plasticized or non plasticized), ethylene/vinyl versatate, vinyl acetate/vinyl versatate, polyacrylics, the copolymers: vinyl acetate/acrylics, the copolymers: styrenic/acrylic, styrene/butadiene, terpolymers: vinyl acetate/vinyl versatate/vinyl maleate, vinyl acetate/vinyl versatate/acrylics, the acrylic terpolymers and mixtures thereof.

7. A compound according to claim 1, further comprising a spreading agent in an amount of from 0.5 to 10%.

8. A compound according to claim 1, further comprising a spreading agent comprising a clay and/or talc and/or mica.

9. A compound according to claim 1, further comprising a workability agent that is a water-retaining agent and a thickener, in an amount of from 1 to 15%.

10. A compound according to claim 1, further comprising a workability agent that is a waterretaining agent and a thickener, the water-retaining agent being a cellulose derivative.

11. A preparation process for a compound as claimed in claim 1, wherein the components of the compound are mixed in any order.

12. A building process for a structure, comprising juxtaposing gypsum boards presenting a facer, and covering the joint between the boards using a compound according to claim 1.

13. A process according to claim 12, comprising juxtaposing gypsum boards, filling a space between the boards using a filling compound, applying tape, covering the tape with the filling compound, then covering the filling compound with a finishing compound, wherein the filling and/or finishing compound is a compound comprising from 50 to 85% of FGD gypsum, in mass percentages based on the total mass of the compound.

14. A process according to claim 12, comprising juxtaposing gypsum boards, applying self-adhesive glass mesh tape, covering the tape with the filling compound, then covering the filling compound with a finishing compound,
characterized in that the filling and/or finishing compound is a compound comprising from 50 to 85% of FGD gypsum, in mass percentages based on the total mass of the compound.

15. A process according to claim 13, wherein the filling and the finishing compound comprises from 50 to 85% of FGD gypsum, in mass percentages based on the total mass of the compound.

16. A compound according to claim 1, comprising a binder in amounts from 1 to 8 weight %.

17. A compound according to claim 1, further comprising a spreading agent in an amount of from 1 to 5%.

18. A process according to claim 12, wherein the facer is paper and further includes applying tape to the gypsum boards.
